(19) United States
(12) Patent Application Publication
(10) Pub. No.: US 2026/0302685 A1
(43) Pub. Date: Oct. 1, 2026

(54) Plug Connector Having Protection Against Steam Jets

(71) Applicant: HIRSCHMANN AUTOMOTIVE GMBH, Rankweil/Brederis (AT)

(72) Inventors: Jonas STURM, Feldkirch (AT); Arno STARZ, Feldkirch (AT); Philipp MAIER, Feldkirch (AT)

(21) Appl. No.: 19/490,173

(22) PCT Filed: Jul. 17, 2024
(86) PCT No.: PCT/EP2024/070331

§ 371 Date: Dec. 4, 2025

(30) Foreign Application Priority Data
Jul. 19, 2023 (DE) 102023119109.8

(51) Int. Cl. H01R 13/52

(52) U.S. Cl. CPC H01R 13/5219

(57) ABSTRACT

A plug connector includes a housing having contact chambers for receiving contact partners. Around all of the contact chambers, a seal is arranged on or in an all-around flange of the housing. The seal seals off the housing of the plug connector with respect to a housing of a mating plug connector or with respect to a housing of an appliance. At least one recess is in the flange adjacent to the seal on the side of the seal which is situated opposite the contact chambers. And the at least one recess in the flange has at least one opening to the outside. A web is set back from the opening.

The invention relates to a plug connector comprising a housing with contact chambers for receiving contact partners, wherein a seal is arranged around all contact chambers on or in a circumferential flange of the housing, wherein the seal seals the housing of the plug connector with respect to a housing of a mating plug connector or with respect to a housing of a device, according to the features of the preamble of claim 1.

The automotive industry is massively increasing sustainability and is increasingly using materials from recycling processes. This leads to an increased susceptibility to corrosion. Crevice corrosion is particularly common in plug connectors with seals. Furthermore, the requirements for steam jet robustness in plug connectors will not be reduced. Experience shows that if the jet hits the seal directly, it cannot withstand the jet and in particular is lifted off.

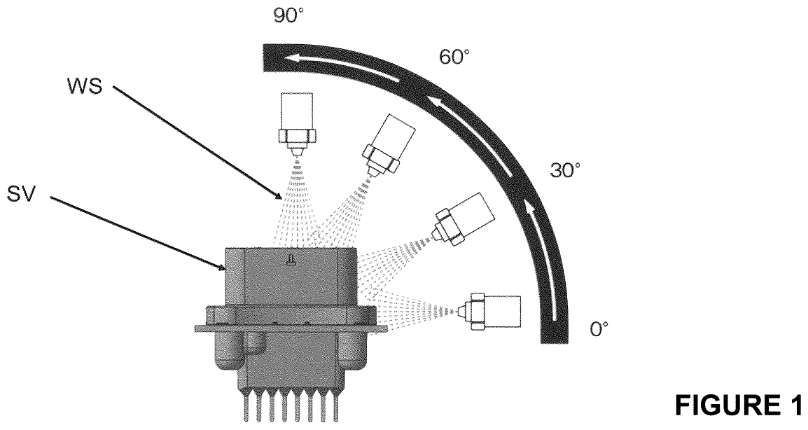

FIG. 1 shows the initial situation in which a plug connector can be exposed to a jet of water, in particular a steam jet, from different directions. FIG. 1 shows four steam jet generators acting from different directions on the plug connector, which is shown schematically. The different directions and the number of steam jet generators are only examples. In practice, when cleaning a vehicle, for example the engine compartment, the plug connector will be exposed to the steam jet, in particular single steam jet, from any chosen direction.

Currently, no plug connectors with housings containing seals are known that provide corrosion resistance when using more cost-effective and recycled materials and/or steam jet tightness.

The problem is particularly the nozzle of the steam jet generator at 0° according to FIG. 1, since it is aimed directly at the seal and its water jet or steam jet is able to penetrate into the gap between seal/housing and/or seal/housing wall.

An increased proportion of recycled materials, especially copper and plastics, reduces the resistance of the plug connector housing material to corrosion.

Another very critical point is design-related gaps and screw holes, which should be sealed if possible. Gaps of at least 0.5 mm are particularly detrimental because they draw in aqueous media due to capillary action, causing crevice corrosion as a result of aeration element formation. Crevice corrosion occurs both between metal/metal and between metal/plastic and their surfaces. Crevice corrosion can also lead to the undermining of seals. Gaps that could give rise to crevice corrosion should be avoided through proper processing.

High-quality and corrosion-resistant base materials are not sustainable and cause high costs that should be avoided.

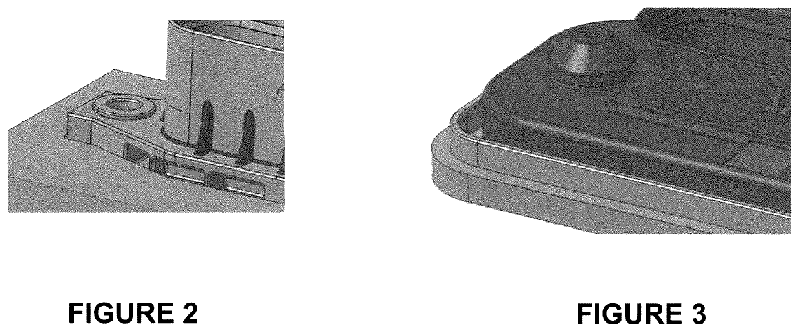

If a water jet hits the seal directly and unimpeded (nozzle 0°), the water jet will penetrate underneath it. The necessary gap to prevent crevice corrosion intensifies this effect. Currently known remedies—prior art—are shown in FIGS. 2 and 3. The plug (connector) is recessed into the housing of a device (FIG. 2). However, this results in costly processing and the risk of stagnant water. A web remains on the housing of the device (FIG. 3). This also results in costly processing and the risk of stagnant water. The housing is specially coated and the plug housing fits 100% flush, and this remains the case even after storage. All these solutions require additional processing, coatings, and material costs. They are not sustainable.

Up to this point and in the following, the terms “water jet” and “steam jet” are used synonymously. Generally speaking, this refers to jets of liquid that are emitted at high pressure to clean parts. This does not refer to jets that have an abrasive effect on the part they strike, due to a hard material (such as sand or similar granular material).

The object of the invention is that of avoiding the disadvantages described at the outset.

This object is achieved by the features of claim 1.

According to the invention, it is provided that in the flange, next to the seal, at least one recess is present on its side opposite the contact chambers, and that the at least one recess in the flange has at least one opening to the outside, wherein a web is arranged set back behind the opening. The recess allows the volume of water jet impacting the plug connector housing from the outside to be collected and directed away via the opening in the flange. This prevents the adverse capillary effects from having any effect and prevents the seal from being undermined. The web set back behind the opening thus advantageously causes a large part of the volume of the water jet striking the housing from the outside to be broken (deflected and unable to penetrate the housing) and only a small part of the volume of the water jet to be directed into the recess and absorbed there. The plug connector according to the invention thus has the advantages that the water jet is broken up or deflected to a large extent by the web set back behind the opening and, moreover, by the surface of the flange on which it strikes (when it hits the side face of the flange). The portion of the water jet that can enter the housing through the opening is further deflected in a targeted manner by the web set back behind the opening and collected in the at least one recess, from which it can be directed away.

The aforementioned advantages are primarily supported by the fact that the plug connector housing is made from a recycled plastic material. This material is cost-effective and sustainable. At the same time, due to the slightly reduced durability of the material resulting from recycling, crevice corrosion is avoided, which would occur without the measures according to the invention.

In a development of the invention, it is provided that several recesses are arranged distributed around the circumference of the seal. This has the advantage that the small volume of the water jet, which has only penetrated the housing through a single opening onto which the water jet has impinged (other openings onto which no water jet or only a smaller part of it impinges may be present), can be collected in these multiple recesses.

In a development of the invention, it is provided that all recesses in the flange have at least one opening to the outside. This has the advantage that, once the volume of the intruding water jet has been collected in several recesses, it can also be discharged from the plug connector housing through these multiple openings.

In a development of the invention, it is provided that a web is arranged behind the flange and runs around the seal, wherein the free end region of the web is lowered relative to the free end region of the flange. The lowered web in front of the seal advantageously prevents a capillary effect. Thus, crevice corrosion does not increase the corrosion, but rather reduces it in a beneficial way.

In a development of the invention, it is provided that the free end region of the web set back behind the opening has the same height as the free end region of the flange. This ensures that the preferably adjacent recesses, separated from the set back ones and the web, are filled with the penetrating volume of the water jet in approximately the same or in the same manner, since the bottom of the opening is set back relative to the free end of the flange and directs the penetrating volume into the two adjacent recesses.

In a development of the invention, it is provided that the bottom of the at least one recess is lower than the free end region of the opening. This provides a sufficiently large volume behind the flange in the plug connector housing for the volume of water jet that still penetrates the housing.

Further advantageous embodiments are specified in the dependent claims.

The invention will be described and explained in more detail below with reference to the figures.

FIG. 1 shows the possible angles of impingement of a water jet WS on a plug connector SV. Only four different directions (0°, 30°, 60° and 90°) are shown as examples from which the water jet WS can impinge on the plug connector SV. In practice, usually only a single beam from an arbitrary, unpredictable direction will impinge on the plug connector.

FIGS. 2 and 3 show disadvantageous embodiments of the plug connector according to the prior art, which have already been mentioned in the introductory description above.

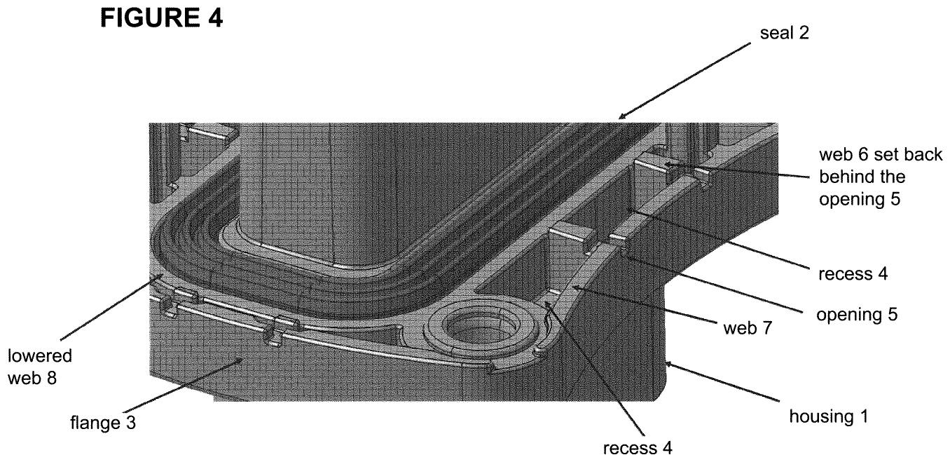

FIG. 4 shows a detail of the plug connector according to the invention. This plug connector has a housing 1 with a seal 2. In its outward-facing region, the housing 1 has a circumferential flange 3. Behind the flange 3 there is at least one recess 4. In the exemplary embodiment shown in FIG. 4, several recesses 4 are distributed around the circumference of the flange 3. In the side wall of the housing 1, which forms the flange 3, at least one opening 5 is provided. Such an opening 5 can be arranged multiple times around the flange 3. If a water jet impinges any point on the flange 3, a large part of its volume will be deflected. However, the smallest part of its volume is specifically directed into the interior of the connector housing 1. The opening 5 is located below the end region of the flange 3 which points upwards in the insertion direction. Furthermore, at least one web 6 is set back behind the opening 5. This web 6 can also be present multiple times, in particular corresponding to the number of openings 5. The circumferential web formed by the flange 3 is marked with the reference numeral 7. Viewed from the outside, there is a lowered circumferential web 8 behind the flange 3. In the exemplary embodiment shown in FIG. 4, the lowered web 8 runs approximately parallel to the seal 2, but can, alternatively, also take a different course than the course of the seal 2. For the sake of completeness, it should be mentioned that the contact region of the plug connector is located within the seal 2. This contact region is formed by a contact carrier which, when viewed in FIG. 4, lies within the seal 2 and which may be (or is) part of the housing 1 and protrudes upwards from the flange 3. Within this contact carrier there is arranged at least one contact chamber (in practice often several contact chambers), with an electrical contact partner being located in each contact chamber. This electrical contact partner (or the multiple contact partners) is (are) contacted with its (their) corresponding contact partner in a mating plug connector when the plug connector shown in a detail in FIG. 4 is inserted into its mating plug connector to form a plugged connection.

The free end region of the web 7 of the flange 3 preferably lies in a common plane with the free end region of the web 6 which is set back behind the opening 5. The bottom of the opening 5 is lowered relative to this plane. The same applies to the free end region of the lowered web 8. The bottom of the opening 5 and the free end region of the lowered web 8 can also lie in a common plane. However, their planes can just as easily differ from each other. Furthermore, the bottom of the recess 4 is advantageously located in a plane that lies below the bottom of the opening 5. This observation applies to the consideration of FIG. 4.

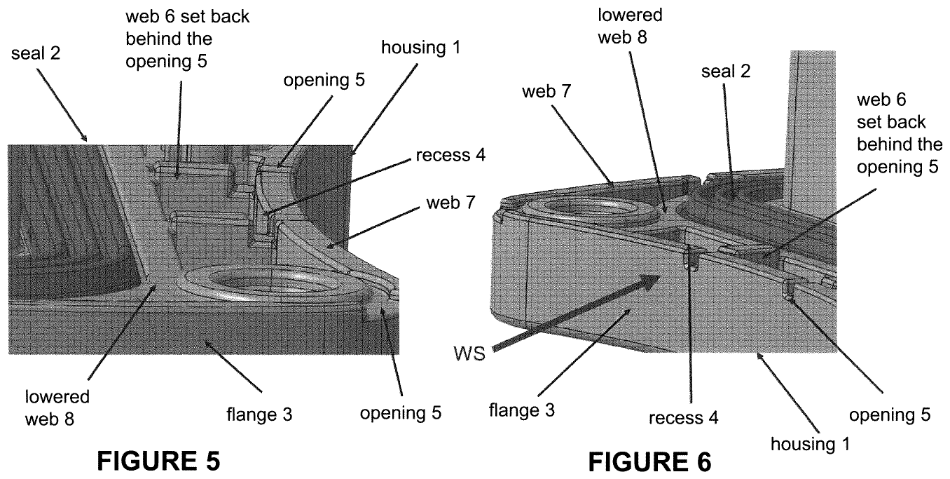

FIG. 5 shows that no capillary effect occurs due to the lowered web 8 in front of the seal 2. Thus, crevice corrosion does not increase the corrosion, but rather it is advantageously reduced or completely prevented. Furthermore, it can be seen that an opening can also be located in the area of a mounting opening (for example designed as a socket) in the housing of the plug connector.

FIG. 6 shows that the outer rib 7 breaks the water jet, so that no direct impingement on the seal 2 is possible and the seal 2 is not thereby undermined.

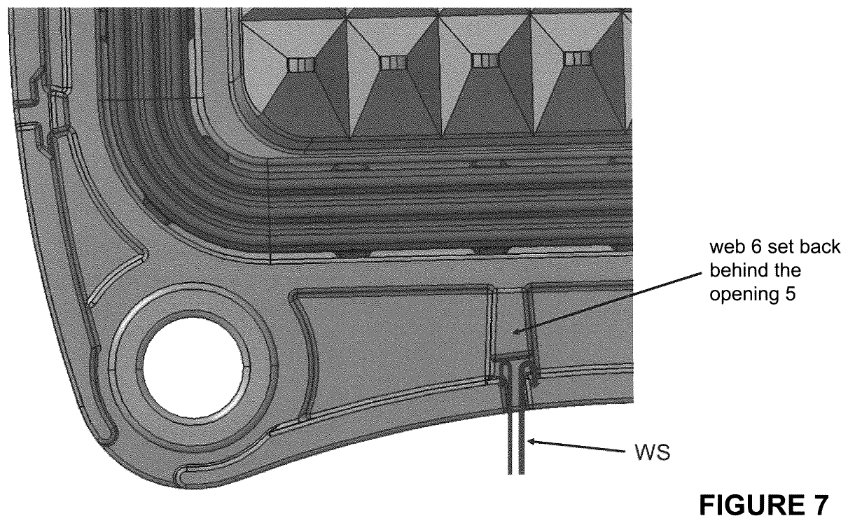

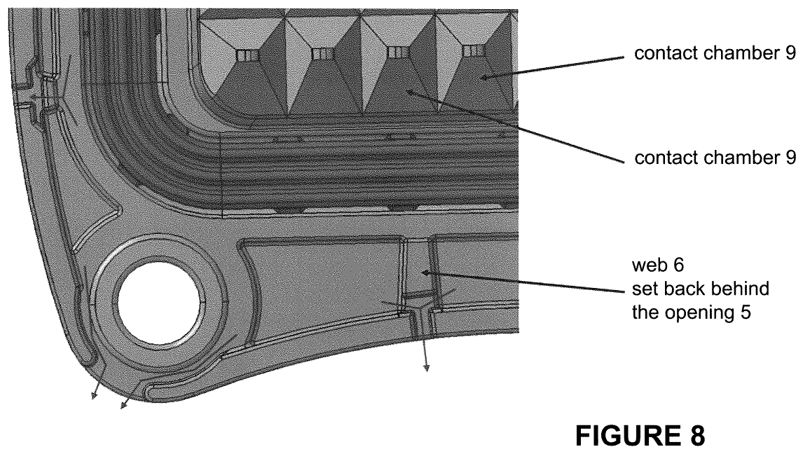

FIG. 7 shows that the water jet WS is “broken” by the covering intermediate wall (web 6) of the clearance and therefore cannot impinge on the seal 2. If a small part of the volume of the incident water jet is directed towards the recess to the right and/or left of the web 6, it can be drained back out of the plug connector housing via the at least one further opening located next to the opening through which it entered. In this regard, reference is made to the following FIG. 8, in which this drained volume is shown in the form of an arrow.

Lastly, FIG. 8 shows that the water can drain away regardless of the position of the plug connector at its installation location. This view also shows several contact chambers 9 of the plug connector, which are arranged within the circumferential seal 2 in a contact carrier of the plug connector. The contact partners in the contact chambers 9 are not shown.

### LIST OF REFERENCE SIGNS

1. housing
2. seal
3. flange
4. recess
5. opening
6. web
7. web
8. lowered web
9. contact chamber
WS water jet
SV plug connector

1.-11. (canceled)

12. A plug connector comprising a housing with contact chambers for receiving contact partners, wherein:
a seal is arranged around all contact chambers on or in a circumferential flange of the housing;
the seal seals the housing of the plug connector with respect to a housing of a mating plug connector or with respect to a housing of a device;
in the flange next to the seal on its side opposite the contact chambers, at least one recess is provided and the at least one recess in the flange has at least one opening to the outside; and
a first web is arranged set back behind the opening.

13. The plug connector according to claim 12, wherein several recesses are arranged distributed around the circumference of the seal.

14. The plug connector according to claim 13, wherein all recesses in the flange have at least one opening to the outside.

15. The plug connector according to claim 12, wherein:
a second web is arranged behind the flange which runs around the seal; and
a free end region of the second web is lowered relative to a free end region of the flange.

16. The plug connector according to claim 12, wherein a free end region of the first web set back behind the opening has the same height as a free end region of the flange.

17. The plug connector according to claim 12, wherein the floor of the at least one recess lies lower than a free end region of the opening.

18. The plug connector according to claim 12, wherein:
a second web is arranged behind the flange which runs around the seal; and
a free end region of the second web of the flange lies in a common plane with a free end region of the first web set back behind the opening; and
the bottom of the opening and/or a free end region of the second web is lowered relative to the common plane.

19. The plug connector according to claim 12, wherein:
a second web is arranged behind the flange which runs around the seal; and
the bottom of the opening and the free end region of the second web lie in a common plane.

20. The plug connector according to claim 12, wherein:
a second web is arranged behind the flange which runs around the seal; and
the bottom of the opening and a free end region of the second web lie in different planes.

21. The plug connector according to claim 12, wherein the bottom of the recess lies in a plane that is below the bottom of the opening.

22. The plug connector according to claim 12, wherein the housing is made of a recycled plastic material.

23. The plug connector according to claim 12, wherein:
several recesses are arranged distributed around the circumference of the seal;
a second web is arranged behind the flange which runs around the seal; and
a free end region of the second web is lowered relative to a free end region of the flange.

24. The plug connector according to claim 23, wherein all recesses in the flange have at least one opening to the outside.

25. The plug connector according to claim 23, wherein:
a free end region of the first web set back behind the opening has the same height as a free end region of the flange; and
the floor of the at least one recess lies lower than a free end region of the opening.

26. The plug connector according to claim 23, wherein:
a free end region of the second web of the flange lies in a common plane with a free end region of the first web set back behind the opening; and
the bottom of the opening and/or a free end region of the second web is lowered relative to the common plane.

27. The plug connector according to claim 23, wherein the bottom of the opening and the free end region of the second web lie in a common plane.

28. The plug connector according to claim 23, wherein the bottom of the opening and a free end region of the second web lie in different planes.

29. The plug connector according to claim 23, wherein the bottom of the recess lies in a plane that is below the bottom of the opening.

30. The plug connector according to claim 23, wherein the housing is made of a recycled plastic material.

31. The plug connector according to claim 12, wherein:
several recesses are arranged distributed around the circumference of the seal;
a second web is arranged behind the flange which runs around the seal;
a free end region of the second web is lowered relative to a free end region of the flange;
all recesses in the flange have at least one opening to the outside; and
the housing is made of a recycled plastic material.
